(19) United States
(12) Patent Application Publication
(10) Pub. No.: US 2026/0316528 A1
(43) Pub. Date: Oct. 15, 2026

(54) WINDSHIELD MOUNT AND VEHICLE

(71) Applicant: KAWASAKI MOTORS, LTD., Hyogo (JP)

(72) Inventor: Jude STEFFEN, Lincoln, NE (US)

(73) Assignee: KAWASAKI MOTORS, LTD., Hyogo (JP)

(21) Appl. No.: 19/635,937

(22) Filed: Apr. 1, 2026

Related U.S. Application Data
(60) Provisional application No. 63/786,149, filed on Apr. 9, 2025.

(51) Int. Cl. B60J 1/00; B60J 1/02; B60N 2/005; B60R 21/13

(52) U.S. Cl. CPC B60J 1/006; B60J 1/02; B60N 2/005; B60R 21/13

(57) ABSTRACT

A windshield mount mounts a windshield located in front of a seat of a vehicle to a vehicle body. The windshield mount includes a holding part holding a lower part of a windshield and an attachment part detachably attached to the vehicle body. The holding part has a shape bent in a front-back direction.

### CROSS-REFERENCE TO RELATED APPLICATION

The present application claims priority to U.S. Provisional Application No. 63/786,149 filed on Apr. 9, 2025, the content of which is incorporated herein by reference.

### TECHNICAL FIELD

The present disclosure relates to a windshield mount and a vehicle.

### BACKGROUND ART

JP 5,988,859 B2 discloses a windshield mount structure.

### SUMMARY

A windshield mount is a windshield mount mounting a windshield located in front of a seat of a vehicle to a vehicle body, including: a holding part holding a lower part of the windshield; and an attachment part detachably attached to the vehicle body, wherein the holding part has a shape bent in a front-back direction.

According to the windshield mount, the windshield mount can be mounted to a vehicle while having the shape bent in the front-back direction.

The objects, features, aspects, and advantages of this disclosure will become more apparent from the following detailed description and the accompanying diagrams.

### BRIEF DESCRIPTION OF DRAWINGS

FIG. 1 is a perspective view illustrating a vehicle.

FIG. 2 is a perspective view illustrating a windshield and a surrounding part thereof

FIG. 3 is a front view illustrating a windshield mount and a surrounding part thereof.

FIG. 4 is a plane view illustrating the windshield mount and the surrounding part thereof.

FIG. 5 is a diagram explaining attachment of the windshield.

FIG. 6 is a cross-sectional view along a VI-VI line in FIG. 3.

FIG. 7 is a perspective view illustrating a windshield mount.

FIG. 8 is a perspective view illustrating the windshield mount.

FIG. 9 is a front view illustrating the windshield mount.

FIG. 10 is a plane view illustrating the windshield mount.

FIG. 11 is a perspective view illustrating a windshield mount according to a modification example.

FIG. 12 is a perspective view illustrating a windshield mount according to a modification example.

FIG. 13 is a cross-sectional view illustrating a seal lip according to a modification example.

### DESCRIPTION OF THE PREFERRED EMBODIMENTS

### First Embodiment

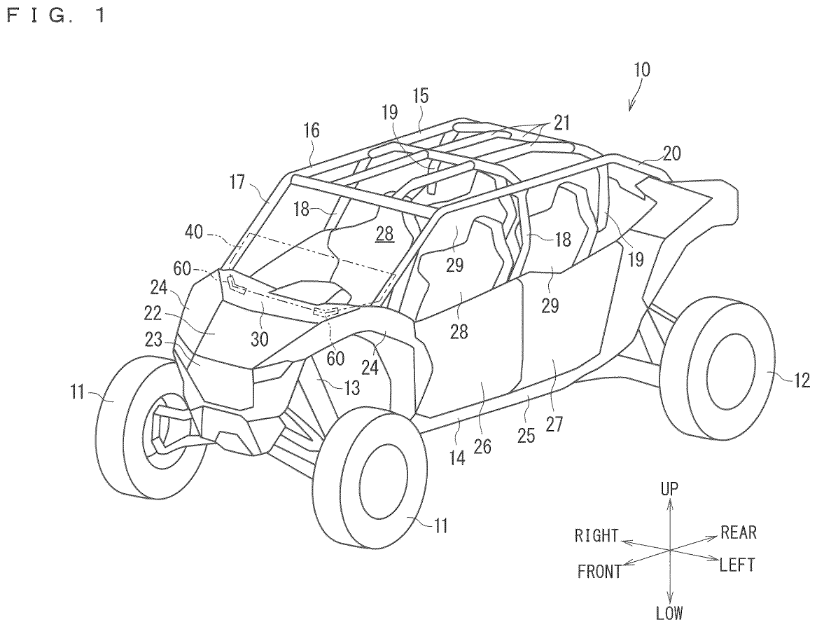

A windshield mount according to a first embodiment and a vehicle including the windshield mount will be hereinafter described. FIG. 1 is a perspective view illustrating a vehicle 10. In the following description, a travel direction of the vehicle 10 may be expressed as FRONT, a direction opposite to the travel direction may be expressed as REAR, a road surface side on which the vehicle 10 travels may be expressed as LOW, and a side opposite to the road surface side may be expressed as UP. A road surface is a ground or a road. RIGHT and LEFT may be referred to while a person stands on a road surface and faces frontward. A right-left direction is a vehicle width direction.

The vehicle 10 is a wheeled vehicle traveling on the road surface. The vehicle 10 may be an off-road vehicle, for example. The off-road vehicle may be a versatile small vehicle suitable for off-road travel rather than for fast travel on a public road.

Examples of the off-road vehicle include a side-by-side vehicle. The side-by-side vehicle is, for example, a small vehicle suitable for all terrain travel, and a vehicle in which passengers can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

The vehicle 10 may be a passenger transport vehicle designed to travel at low speeds within a limited area.

Examples of the limited area may include limited community areas, private roads, and private lands (e.g., golf courses and parks). The limited community areas are areas provided for use by community residents. The community areas are, for example, areas including houses and public facilities (e.g., schools and hospitals), and are areas in which the vehicle 10 designed to travel through non-public highways are permitted to travel at low speeds. The low speed is, for example, a speed with an upper limit ranging from 20 mph to 30 mph. The vehicle 10 includes a personal transport vehicle (PTV) in accordance with ANSI/ILTVA Z135 and a golf cart in accordance with ANSI/ILTVA Z130.1. The vehicle 10 includes a personal transportation electric vehicle.

The vehicle 10 includes front wheels 11, rear wheels 12, and a vehicle body 14. The vehicle 10 includes a travel drive apparatus and a steering apparatus not shown in the diagrams.

The vehicle body 14 has a support structure supporting each part of the vehicle 10. The vehicle body 14 includes a vehicle body frame 15, for example. Herein, the vehicle body frame 15 includes a rollover protective structure (ROPS) 16. The ROPS 16 has a structure that roll bars each made up of a metal pipe are connected, for example. The roll bar includes a front pillar part 17, intermediate pillar parts 18 and 19, a rear pillar part 20, and a roof pole part 21. The front pillar part 17 extends upward from a front side of a front seat 28. The intermediate pillar parts 18 and 19 extend upward from a back side of the front seat 28. The rear pillar part 20 extends upward from a position more backward than the intermediate pillar parts 18 and 19. The front pillar part 17, the intermediate pillar parts 18 and 19, and the rear pillar part 20 are provided in a pair on right and left sides. The roof pole part 21 connects the front pillar part 17, the intermediate pillar parts 18 and 19, and the rear pillar part 20. The roof pole part 21 is provided in a lattice form herein. The roof pole part 21 includes a part extending in a front-back direction and a part extending in a vehicle width direction. Herein, the front pillar part 17, a part of the roof pole part 21 extending in a front-back direction, and the rear pillar part 20 constitute one arch-like roll bar.

The vehicle body 14 includes a floor part 25. The floor part 25 is located in a lower part of a space for passengers. The floor part 25 is a part including a surface for supporting feet of a passenger during traveling or for a passenger getting in and out of the vehicle to place feet for movement. The floor part 25 is a plate-like part spreading in a horizontal direction. The vehicle body frame 15 may include a ladder frame constituting the floor part 25. The floor part 25 may be a floor plate or a part in which a ladder frame and a floor plate are combined. The vehicle body 14 may have a monocoque structure.

The front wheels 11 and the rear wheels 12 are rotatably supported on the vehicle body 14. The front wheels 11 and the rear wheels 12 may be supported on the vehicle body 14 via a suspension apparatus 13. For example, two front wheels 11 are rotatably supported on right and left portions in a front part of the floor part 25. One front wheel 11 is also applicable. For example, two rear wheels 12 are rotatably supported on right and left portions in a rear part of the floor part 25.

The vehicle body 14 may include a panel-like member. A dashboard panel 30, a hood 22, a front cover 23, or a front side cover 24, for example, may be provided as well as the floor plate as the panel-like member. The dashboard panel 30 is located in front of a driver seat. The hood 22 is located in front of the dashboard panel 30. The front cover 23 is located in a lower part of a front end of the hood 22. The front side cover 24 is located on a lateral side of the dashboard panel 30, the hood 22, and the front cover 23.

The vehicle 10 includes seats. The vehicle 10 includes a front seat 28 and a rear seat 29 herein. It is also applicable that the vehicle 10 does not include the rear seat 29 but includes only the front seat 28. The floor part 25 is located below the front seat 28 and the rear seat 29. The front seat 28 and the rear seat 29 are supported by the floor part 25. The front seat 28 is located above the floor part 25 and more backward than the dashboard panel 30. The front seat 28 is located more frontward than the rear seat 29. The front seat 28 includes the driver seat.

The vehicle body 14 includes doors 26 and 27 herein. The door 26 is located in a lateral side of the front seat 28. A passenger of the front seat 28 opens and closes the door 26 when getting in and out of the vehicle 10. The door 27 is located in a lateral side of the rear seat 29. A passenger of the rear seat 29 opens and closes the door 27 when getting in and out of the vehicle 10. The vehicle 10 may be a vehicle in which at least two passengers can ride side by side.

The vehicle 10 may be opened outside of the seats in a vehicle width direction without being obstructed by walls or the doors 26 and 27 to facilitate the passengers getting in and out of the vehicle 10. In this case, the passenger can walk past in a right-left direction without being obstructed by the doors 26 and 27 or the walls.

The travel drive apparatus is an apparatus for making the vehicle 10 travel. The travel drive apparatus is supported on the vehicle body 14. The travel drive apparatus includes a motor, for example. The motor may be an electrical motor or an internal combustion engine. For example, a rotation shaft of the motor is connected to a shaft of a drive wheel directly or via a gear. When rotation drive force of the motor is transmitted to the drive wheel, the vehicle 10 can travel. The motor may be located between two rear wheels 12, for example.

The steering apparatus is an apparatus for controlling a travel operation of the vehicle 10. The travel operation is traveling, stopping, a speed, and a travel direction of the vehicle 10, for example.

The steering apparatus includes a steering wheel located more backward than the front wheel 11, for example. The steering wheel is rotatably supported by a steering shaft. The steering wheel is located closer to a front side on the floor part 25. The steering wheel is located more frontward than the front seat 28. The steering shaft is connected to the front wheel 11 via a steering gear, for example. The front wheel 11 is rotated around a steering shaft by an operation of the steering wheel. The travel direction of the vehicle 10 is changed by rotation of the front wheel 11 around the steering shaft.

The dashboard panel 30 is located more frontward than the steering wheel. Meters displaying a speed meter and a battery remaining amount, for example, may be disposed in the dashboard panel 30. An operation pedal may be disposed in a position on the lower side than the steering wheel. The operation pedal may be one pedal capable of controlling start, acceleration, deceleration, and stop by adjusting a degree of pressing the pedal, for example. The operation pedal may be a brake pedal and an acceleration pedal.

The driver seat is located in back of the steering wheel. A driver can be seated on the driver seat to operate the steering wheel and the operation pedal. The vehicle 10 may be a remotely-operated vehicle or an autonomously-traveling vehicle. In this case, the steering wheel and the operation pedal may be omitted.

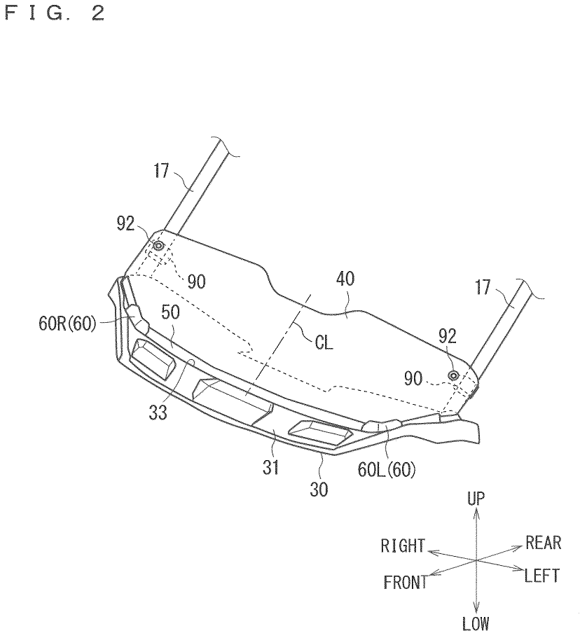

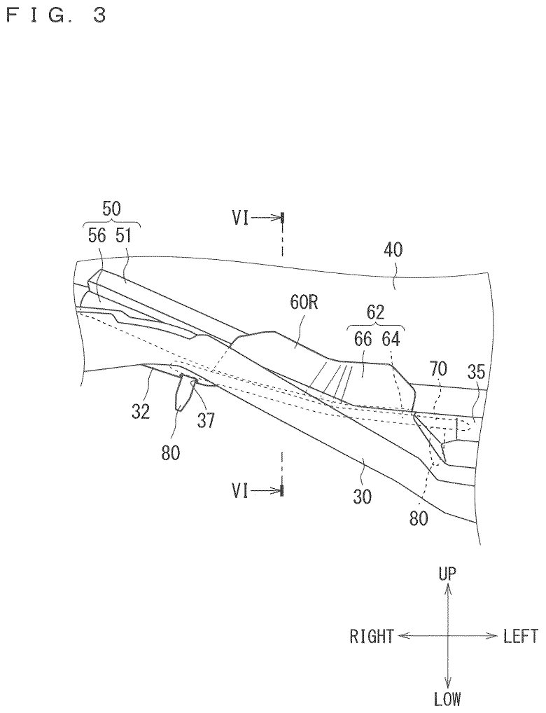

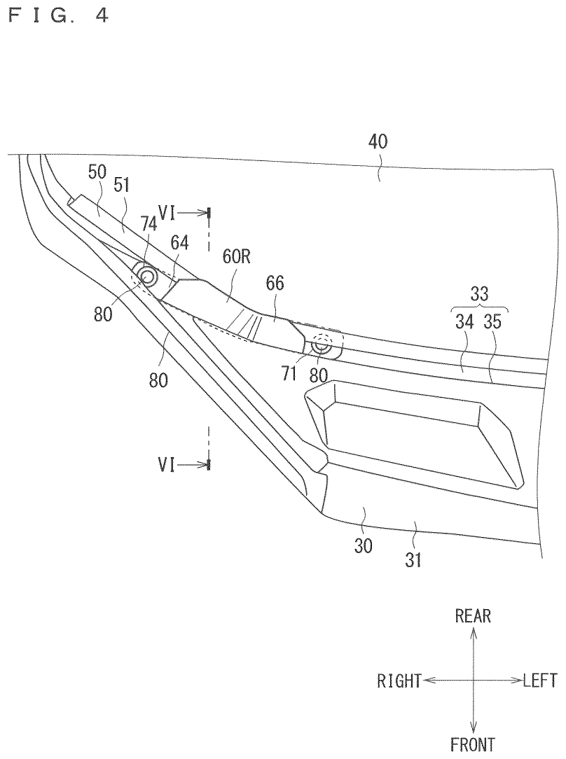

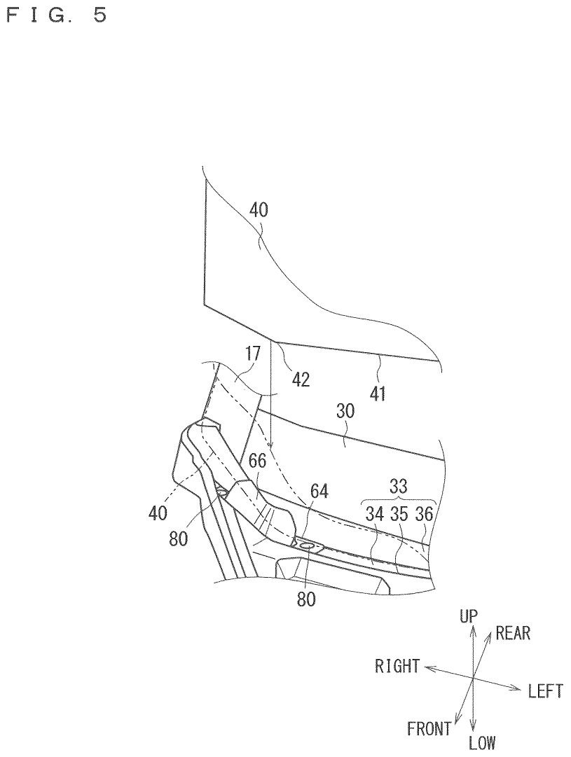

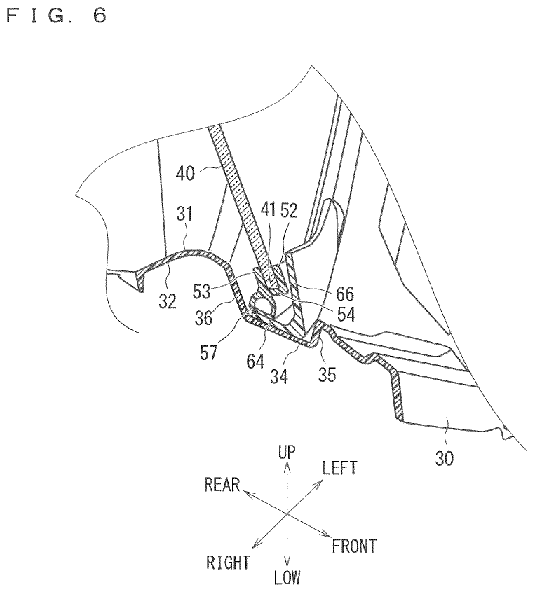

The vehicle 10 includes a windshield 40 and a windshield mount 60. The windshield 40 and the windshield mount 60 are further described with reference to FIG. 2 and FIG. 6. FIG. 2 is a perspective view illustrating the windshield 40 and a surrounding part thereof. FIG. 3 is a front view illustrating a windshield mount 60R and a surrounding part thereof. FIG. 4 is a plane view illustrating the windshield mount 60R and the surrounding part thereof. FIG. 5 is a diagram explaining attachment of the windshield 40. FIG. 6 is a cross-sectional view along a VI-VI line in FIG. 3.

The windshield 40 is located in front of the front seat 28 of the vehicle 10. The windshield mount 60 mounts the windshield 40 the vehicle body 14. A lower end of the windshield 40 is supported on the dashboard panel 30 by the windshield mount 60.

The dashboard panel 30 includes an upper surface 31 and a lower surface 32. A groove 33 is formed in the upper surface 31 of the dashboard panel 30. The groove 33 extend in a vehicle width direction. The groove 33 extends from a left end to a right end of the dashboard panel 30 along the vehicle width direction. The groove 33 includes a bottom part 34, a front wall 35, and a rear wall 36. The front wall 35 protrudes upward from a front edge of the bottom part 34. The rear wall 36 protrudes upward from a rear edge of the bottom part 34. An area between an upper end of the front wall 35 and an upper end of the rear wall 36 serves as an upper opening of the groove 33. A protrusion dimension of the rear wall 36 from the bottom part 34 is larger than that of the front wall 35 from the bottom part 34. A lower edge 41 of the windshield 40 is inserted from the upper opening of the groove 33, and is disposed inside the groove 33.

The windshield mount 60 is located inside the groove 33. The lower edge 41 of the windshield 40 is inserted from the upper opening of the groove 33, thereby being supported on the windshield mount 60.

The dashboard panel 30 includes a part protruding more frontward than the groove 33 and a part protruding more backward than the groove 33. A passenger seated on the front seat 28 can have access to the part of the dashboard panel 30 protruding more backward than the groove 33.

The windshield 40 is formed by transparent resin such as polycarbonate, for example. The windshield 40 has flexibility. The windshield 40 is attached to the vehicle body 14 in a posture inclined with respect to an up-down direction. It is also applicable that the flat windshield 40 is bent in a thickness direction in attachment to the vehicle body 14, and the windshield mount 60 holds the windshield 40 in a bent state. The windshield 40 may be bent in the thickness direction so that an outer part in the vehicle width direction is located more backward than a center part in the vehicle width direction. When the flat windshield 40 is bent in the thickness direction, the windshield mount 60 may hold a position on which most stress is applied. It is also applicable that the windshield 40 cannot keep a predetermined bent shape without the windshield mount 60. It is also applicable that the windshield 40 is previously formed into a shape bent in the thickness direction and can keep the bent shape even without the windshield mount 60.

In FIG. 5, the windshield 40 illustrated by a solid line shows a state before bent in the thickness direction. In FIG. 5, the windshield 40 illustrated by a virtual line shows a state after bent in the thickness direction.

The lower edge 41 of the windshield 40 may be previously formed into a shape bent in the up-down direction in a state before the windshield 40 is bent in the thickness direction. The lower edge 41 of the windshield 40 may have a shape that an outer part in the vehicle width direction is located on an upper side than a center part in the vehicle width direction. A bending part 42 having a smaller curvature radius than the other position may be set in the lower edge 41 of the windshield 40. The bending part 42 of the lower edge 41 of the windshield 40 may be provided in a position corresponding to the windshield mount 60.

An upper part of the windshield 40 is fixed to the front pillar parts 17 on right and left sides. The front pillar part 17 extends in the up-down direction through a position more backward than the dashboard panel 30. A bracket 90 is provided to a part of the front pillar part 17 located on an upper side than the dashboard panel 30. For example, the bracket 90 includes an exterior part externally mounted to the front pillar part 17 and an inner protruding part protruding inside in the vehicle width direction from the exterior part. The upper part of the windshield 40 is fixed to the inner protruding part of the bracket 90 by a fixing member 92. Accordingly, suppressed is movement of the upper end of the windshield 40 with respect to the vehicle body 14. The bracket 90 may be detachable from the front pillar part 17. The fixing member 92 may be detachable from the windshield 40 and the bracket 90. The fixing member 92 may be a bolt, a rivet, or a clamp, for example.

The windshield mount 60 supports the windshield 40 from a front lower side. Herein, the lower part of the windshield 40 is merely supported by the vehicle body 14, and is not fixed thereto. Thus, the lower part of the windshield 40 can be movable with respect to the vehicle body 14. The windshield mount 60 suppresses the movement of the lower part of the windshield 40. Furthermore, a seal lip 50 is provided to suppress the movement of the lower part of the windshield 40.

Furthermore, the seal lip 50 is fitted to the lower edge 41 of the windshield 40. The seal lip 50 includes a fitting part 51 and an elastic part 56. The seal lip 50 is formed of an elastic material such as rubber or elastomer. The seal lip 50 may be a molded component molded to have an integral shape with the fitting part 51 and the elastic part 56.

The fitting part 51 is a part into which the lower edge 41 of the windshield 40 is fitted. The fitting part 51 has a U-like shape in a cross-sectional view. The fitting part 51 includes a front sandwiching piece 52, a rear sandwiching piece 53, and a connection piece 54. The front sandwiching piece 52 has contact with a front surface of the windshield 40. The rear sandwiching piece 53 has contact with a rear surface of the windshield 40. The connection piece 54 connect a lower end of the front sandwiching piece 52 and a lower end of the rear sandwiching piece 53. The front sandwiching piece 52 and the rear sandwiching piece 53 sandwich the lower edge 41 of the windshield 40.

A rib extending along the vehicle width direction may be provided to each of a surface of the front sandwiching piece 52 having contact with the windshield 40 and a surface of the rear sandwiching piece 53 having contact with the windshield 40. The plurality of ribs may be provided at intervals in the up-down direction. The rib can suppress ingress of water inside the fitting part 51.

The elastic part 56 protrudes from an outer surface of the fitting part 51. Herein, the elastic part 56 includes a cylindrical part 57 having a cylindrical shape in a cross-sectional view. The elastic part 56 can be deformed to be compressed between the windshield 40 and an arrangement counterpart. Accordingly, a gap between the windshield 40 and the arrangement counterpart can be reduced. FIG. 6 illustrates the compressed cylindrical part 57.

The windshield mount 60 is attached to the dashboard panel 30. The windshield mount 60 includes a first windshield mount 60L and a second windshield mount 60R. The first windshield mount 60L is attached to a left part of the dashboard panel 30 along the vehicle width direction. The second windshield mount 60R is attached to a right part of the dashboard panel 30 along the vehicle width direction.

The first windshield mount 60L on the left side is closer to a left end part of the windshield 40 in the vehicle width direction in relation to a center thereof in the vehicle width direction. The second windshield mount 60R on the right side is closer to a right end part of the windshield 40 in the vehicle width direction in relation to the center thereof in the vehicle width direction. A line CL in FIG. 2 shows the center of the windshield 40 in the vehicle width direction. A left end of the windshield 40 is a part fixed to the front pillar part 17 on the left side. A right end of the windshield 40 is a part fixed to the front pillar part 17 on the right side. The windshield mount 60L is closer to the left end of the windshield 40 in relation to the line CL. The windshield mount 60R is closer to the right end of the windshield 40 in relation to the line CL.

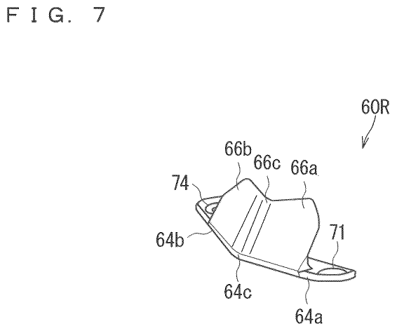

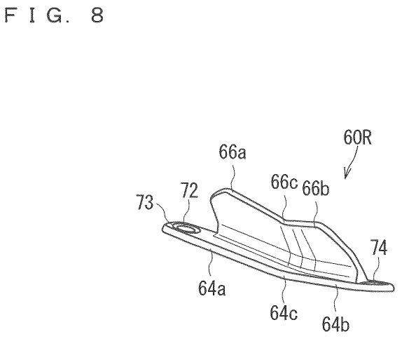

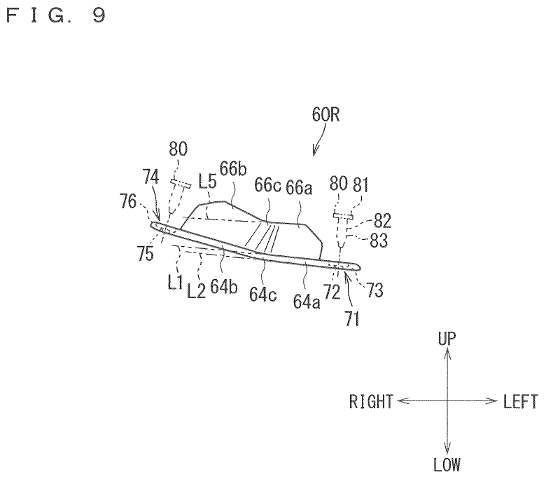

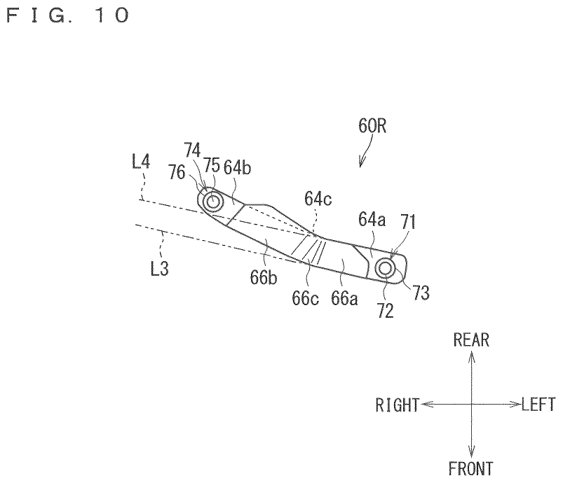

A shape of the windshield mount 60R is described hereinafter further with reference to FIG. 7 to FIG. 10. FIG. 7 and FIG. 8 are perspective views each illustrating the windshield mount 60R. FIG. 9 is a front view illustrating the windshield mount 60R. FIG. 10 is a plane view illustrating the windshield mount 60R. The shape of the windshield mount 60L and the shape of the windshield mount 60R are bilaterally symmetrical. The shape of the windshield mount 60R is also applied to the shape of the windshield mount 60L unless any contradiction particularly occurs.

The windshield mount 60R includes a holding part 62 and an attachment part 70. The holding part 62 holds the lower part of the windshield 40. The attachment part 70 is detachably attached to the vehicle body 14. The windshield mount 60R is a resin or metal member. The windshield mount 60R has higher rigidity than the seal lip 50.

The holding part 62 includes a lower retaining part 64 and a front retaining part 66. The lower retaining part 64 is located on a lower side than the windshield 40. The front retaining part 66 extends upward from a front edge part of the lower retaining part 64. The front retaining part 66 holds the lower part of the windshield 40 from the front side. Herein, the front retaining part 66 extends to an upper back side from the front edge part of the lower retaining part 64. For example, the front retaining part 66 is an inclined surface extending along an inclination of the windshield 40.

The holding part 62 has a shape bent in the front-back direction. Herein, each of the lower retaining part 64 and the front retaining part 66 is bent in the front-back direction. The holding part 62 has a shape bent in the front-back direction in a top view. The holding part 62 is bent in the front-back direction as proceeding in the vehicle width direction. Specifically, the holding part 62 is bent toward the back side as proceeding outside in the vehicle width direction. The holding part 62 has an inclined shape inclined backward as proceeding outside in the vehicle width direction.

The holding part 62 has a shape bent in the up-down direction. Herein, each of the lower retaining part 64 and the front retaining part 66 are bent in the up-down direction. The holding part 62 is bent in the up-down direction in a front view. The holding part 62 is bent in the up-down direction as proceeding in the vehicle width direction. Specifically, the holding part 62 is bent toward the upper side as proceeding outside in the vehicle width direction. The holding part 62 has an inclined shape inclined upward as proceeding outside in the vehicle width direction. A bending position in the front-back direction and a bending position in the up-down direction are the same position.

The lower retaining part 64 includes an inner part 64a, an outer part 64b, and a bending part 64c. The inner part 64a is a part of the lower retaining part 64 located inside in the vehicle width direction. The outer part 64b is a part of the lower retaining part 64 located outside in the vehicle width direction. The bending part 64c is located between the inner part 64a and the outer part 64b. The inner part 64a and the outer part 64b are connected via the bending part 64c. The bending part 64c is a part of the lower retaining part 64 bent in the front-back direction and the up-down direction. Each of the inner part 64a and the outer part 64b is formed into an elongated plate-like shape.

In a front view illustrated in FIG. 9, a plate part constituting the outer part 64b is bent in a thickness direction with respect to a plate part constituting the inner part 64a. Accordingly, the lower retaining part 64 is bent in the up-down direction. In FIG. 9, the line L1 is a virtual line that an upper surface of the inner part 64a extends outside. A line L2 is a virtual line that a lower surface of the inner part 64a extends outside. An upper surface of the outer part 64b extends more upward than the virtual line L1. A lower surface of the outer part 64b extends more upward than the virtual line L2.

In a plane view illustrated in FIG. 10, an extension direction of the plate part constituting the inner part 64a located on an inner side than the bending part 64c and an extension direction of the plate part constituting the outer part 64b located on an outer side than the bending part 64c are different from each other. Accordingly, the lower retaining part 64 is bent in the front-back direction. In FIG. 10, a line L3 is a virtual line that a front edge of the inner part 64a extends outside. A line L4 is a virtual line that a back edge of the inner part 64a extends outside. A front edge of the outer part 64b extends more backward than the virtual line L3. A back edge of the outer part 64b extends more backward than a virtual line L4.

The front retaining part 66 includes an inner part 66a, an outer part 66b, and a bending part 66c. The inner part 66a is a part of the front retaining part 66 located inside in the vehicle width direction. The outer part 66b is a part of the front retaining part 66 located outside in the vehicle width direction. The bending part 66c is located between the inner part 66a and the outer part 66b. The inner part 66a and the outer part 66b are connected via the bending part 66c. The bending part 66c is a part of the front retaining part 66 bent in the front-back direction and the up-down direction. Each of the inner part 66a and the outer part 66b is formed into an elongated plate-like shape. Since a lower edge of the front retaining part 66 is continuously formed with the lower retaining part 64, the lower edge of the front retaining part 66 is bent in the manner similar to the lower retaining part 64.

In a front view illustrated in FIG. 9, an extension direction of a plate part constituting the inner part 66a located on an inner side than the bending part 66c and an extension direction of a plate part constituting the outer part 66b located on an outer side than the bending part 66c are different from each other. Accordingly, the lower retaining part 64 is bent in the front-back direction. In FIG. 9, a line L5 is a virtual line that an upper edge of the inner part 66a extends outside. An upper edge of the outer part 66b extends more upward than the virtual line L5.

The plate part constituting the outer part 66b is bent in a thickness direction with respect to the plate part constituting the inner part 66a. Accordingly, the front retaining part 66 is bent in the front-back direction. In FIG. 10, a line L4 is a virtual line that an upper edge of the inner part 66a extends outside. An upper edge of each of the outer parts 64b and 66b extends more backward than the virtual line L4.

The attachment part 70 includes an outer attachment part 74 and an inner attachment part 71. The outer attachment part 74 is located in an outer end part of the lower retaining part 64 in the vehicle width direction. The inner attachment part 71 is located in an inner end part of the lower retaining part 64 along the vehicle width direction. The attachment part 70 includes an attachment hole parts 72 and 75. The attachment hole parts 72 and 75 are located in both end parts of the lower retaining part 64 in the vehicle width direction. The attachment hole parts 72 and 75 are through holes passing through the lower retaining part 64 in the up-down direction. The attachment hole part 72 is located in one end part of the lower retaining part 64 in the vehicle width direction. The attachment hole part 75 is located in the other end part of the lower retaining part 64 in the vehicle width direction.

Herein, a length of the lower retaining part 64 in the vehicle width direction is larger than that of the front retaining part 66 in the vehicle width direction. The lower retaining part 64 protrudes to both sides in the vehicle width direction with respect to the front retaining part 66. The attachment hole parts 72 and 75 are formed in a part of the lower retaining part 64 protruding outside in the vehicle width direction with respect to the front retaining part 66 to constitute the outer attachment part 74. The attachment hole parts 72 and 75 are formed in a part of the lower retaining part 64 protruding inside in the vehicle width direction with respect to the front retaining part 66 to constitute the inner attachment part 71.

The length of the lower retaining part 64 in the vehicle width direction is larger than that of the front retaining part 66 in the vehicle width direction. The outer attachment part 74 is located on an outer side than the front retaining part 66 along the vehicle width direction. The inner attachment part 71 is located on an inner side than the front retaining part 66 along the vehicle width direction.

As illustrated in FIG. 9, a position of the outer attachment part 74 in the up-down direction is higher than that of the inner attachment part 71. For example, a lower surface of the outer part 64b at the position of the outer attachment part 74 is located on an upper side than the virtual line L1. For example, the upper surface of the outer part 64b at the position of the outer attachment part 74 is located on a lower side than the virtual line L5.

As illustrated in FIG. 10, a position of the outer attachment part 74 in the front-back direction is located more backward than the position of the inner attachment part 71. For example, the outer attachment part 74 is located more backward than the virtual line L4.

The lower retaining part 64 is bent at a position of the bending part 64c in the thickness direction. Thus, an axial direction of the attachment hole part 72 formed in the inner part 64a inside the bending part 64c and an axial direction of the attachment hole part 75 formed in the outer part 64b outside the bending part 64c are not parallel to each other.

The attachment part 70 of the windshield mount 60R is attached to at least one of the left part and the right part (the right part herein) of the vehicle body 14 along the vehicle width direction. The holding part 62 of the windshield mount 60R holds one of the left part and the right part (the right part herein) of the lower part of the windshield 40 along the vehicle width direction.

The attachment part 70 of the windshield mount 60L is attached to a left part of the vehicle body 14 along the vehicle width direction. The holding part 62 of the windshield mount 60L holds the left part of the lower part of the windshield 40 along the vehicle width direction.

The windshield mount 60 is disposed in the groove 33. A lower surface of the lower retaining part 64 has contact with an upper surface of the bottom part 34. An insertion hole 37 is formed in a position in the bottom part 34 corresponding to the attachment hole parts 72 and 75. The front wall 35 is located in front of the front retaining part 66.

The windshield mount 60 is attached to the dashboard panel 30 by an attachment member, for example. Herein, the attachment member is a rivet 80. As illustrated in FIG. 9, the rivet 80 includes a head part 81 and a columnar part 82 protruding from the head part 81. A locking part 83 is provided to the columnar part 82. For example, it is also applicable that an intermediate part of the columnar part 82 along an extension direction is thicker than the other part to constitute the locking part 83. The attachment member needs not be the rivet 80, but may be a screw or a clamp, for example.

The rivet 80 is inserted into the attachment hole parts 72 and 75 and the insertion hole 37 from an upper side than the lower retaining part 64. A distal end of the rivet 80 passes through the dashboard panel 30. As illustrated in FIG. 3, the locking part 83 of the rivet 80 is locked to the lower surface 32 of the dashboard panel 30.

A depression 73 is formed around the attachment hole part 72 in the upper surface of the lower retaining part 64. A depression 76 is formed around the attachment hole part 75 in the upper surface of the lower retaining part 64. The head part 81 of the rivet 80 is housed in the depressions 73 and 76. Accordingly, a protrusion dimension of the head part 81 of the rivet 80 protruding to an upper side than the upper surface of the lower retaining part 64 can be reduced. A depth of each of the depressions 73 and 76 may be equal or larger than a thickness of the head part 81 of the rivet 80. In this case, the head part 81 of the rivet 80 does not protrude to the upper side than the upper surface of the lower retaining part 64.

The windshield mount 60 may be disposed in a position in the lower part of the windshield 40 having a smallest curvature radius. A part of the windshield 40 between the first windshield mount 60L on the left side and the second windshield mount 60R on the right side may be curved more gently than the bending part 42.

As illustrated in FIG. 6, an upper end of the front retaining part 66 is located on an upper side than an upper end of the front wall 35. The windshield mount 60 suppresses the windshield 40 passing over the front wall 35 to the front side. An upper end of the fitting part 51 of the seal lip 50 is located on an upper side than the upper end of the front wall 35. An upper end of the front retaining part 66 is located on an upper side than the upper end of the fitting part 51 of the seal lip 50.

When the windshield 40 is kept in the bent state in the thickness direction, bending stress is applied to the windshield 40. The windshield mount 60 may receive the bending stress in a position where the windshield mount 60 is located. The front wall 35 of the groove 33 may receive the bending stress in a position where the windshield mount 60 is not located.

The bending stress may be biasedly applied to the windshield 40 in the vehicle width direction. The position of the windshield mount 60 may be a part to which large bending stress is applied. A bending state where the left end and the right end of the flat windshield 40 illustrated by a solid line in FIG. 5 get close to each other is a natural bending state. Dispersion of the bending stress in the natural bending state is a natural stress dispersion state. The windshield 40 in a state of being attached to the vehicle body 14 may not be in the natural bending state. The windshield mount 60 may block the natural stress dispersion state of the bending stress of the windshield 40.

A part of the windshield 40 disposed in a position in which the windshield mount 60 is located has contact with the upper surface of the lower retaining part 64. Herein, the elastic part 56 of the seal lip 50 has contact with the upper surface of the lower retaining part 64. The elastic part 56 may be sandwiched between the windshield 40 and the upper surface of the lower retaining part 64 and elastically deformed to be compressed. Accordingly, ingress of water into a side on which the seat is located from a gap between the windshield 40 and the lower retaining part 64 can be suppressed.

A part of the windshield 40 disposed in the position in which the windshield mount 60 is not located has contact with the bottom part 34 of the groove 33. Herein, the elastic part 56 of the seal lip 50 has contact with the bottom part 34 of the groove 33. The elastic part 56 may be sandwiched between the windshield 40 and the bottom part 34 of the groove 33 and elastically deformed to be compressed. Accordingly, ingress of water into the side on which the seat is located from the gap between the windshield 40 and the bottom part 34 of the groove 33 can be suppressed.

The groove 33 may be a drain groove for discharging water flowing down the windshield 40. The dashboard panel 30 may include a drainage hole for flowing water flowing in the groove 33 to a lower side than the dashboard panel 30. A position of the drainage hole may be located in the bottom part 34 of the groove 33, the lower part of the front wall 35, or the lower part of the rear wall 36, for example.

### Effect Etc.

According to the windshield mount 60 having the above configuration and the vehicle 10 including the windshield mount 60, the holding part 62 can hold the part of the windshield 40 bent in the front-back direction.

The holding part 62 includes the lower retaining part 64 located on the lower side than the windshield 40 and the front retaining part 66 extending upward from the front edge part of the lower retaining part 64 to hold the lower part of the windshield 40 from the front side. Accordingly, the lower retaining part 64 and the front retaining part 66 can hold the windshield 40.

Each of the lower retaining part 64 and the front retaining part 66 is bent in the front-back direction. In this case, the lower retaining part 64 and the front retaining part 66 can hold the part of the windshield 40 bent in the front-back direction.

The attachment part 70 includes the attachment hole parts 72 and 75 in both end parts of the lower retaining part 64 in the vehicle width direction. In this case, the lower retaining part 64 can be supported on the vehicle body 14.

The length of the lower retaining part 64 in the vehicle width direction is larger than that of the front retaining part 66 in the vehicle width direction. In this case, the attachment hole can be provided to a part of the lower retaining part 64 protruding in the vehicle width direction more than the front retaining part 66.

The holding part 62 has the shape bent in the up-down direction. The holding part 62 can hold the part of the windshield 40 bent in the up-down direction.

Each of the lower retaining part 64 and the front retaining part 66 is bent in the up-down direction. In this case, the lower retaining part 64 and the front retaining part 66 can hold the part of the windshield 40 bent in the up-down direction.

The attachment part 70 is attached to at least one of the left part and the right part of the vehicle body 14 along the vehicle width direction, and the holding part 62 holds one of the left part and the right part of the lower part of the windshield 40 along the vehicle width direction. In this case, one windshield mount 60 can mount one of the right and left sides of the windshield 40 to the vehicle body 14.

According to the vehicle 10 having the above configuration, the windshield 40 can be attached to be bent in the front-back direction using the windshield mount 60 in the vehicle 10 such as a side-by-side vehicle including the ROPS 16, for example.

The attachment part 70 includes the outer attachment part 74 located in the outer end part of the lower retaining part 64 in the vehicle width direction and the inner attachment part 71 located in the inner end part of the lower retaining part 64 in the vehicle width direction. Accordingly, the lower retaining part 64 can be supported on the vehicle body 14.

The length of the lower retaining part 64 in the vehicle width direction is larger than that of the front retaining part 66 in the vehicle width direction, the outer attachment part 74 is located on the outer side than the front retaining part 66 along the vehicle width direction, and the inner attachment part 71 is located on the inner side than the front retaining part 66 along the vehicle width direction. In this case, the front retaining part 66 hardly becomes an obstacle when each of the outer attachment part 74 and the inner attachment part 71 is attached to the vehicle body 14.

The position of the outer attachment part 74 in the up-down direction is higher than that of the inner attachment part 71. Accordingly, the holding part 62 can hold the windshield 40 to be bent upward from the inner attachment part 71 toward the outer attachment part 74.

The position of the outer attachment part 74 in the front-back direction is located more backward than the position of the inner attachment part 71. Accordingly, the holding part 62 can hold the windshield 40 to be bent backward from the inner attachment part 71 toward the outer attachment part 74.

Herein, the position of the outer attachment part 74 in the up-down direction is located on the upper side than the position of the inner attachment part 71, and the position of the outer attachment part 74 in the front-back direction is located more backward than the position of the inner attachment part 71. Accordingly, the holding part 62 can hold the windshield 40 to be bent upward and backward from the inner attachment part 71 toward the outer attachment part 74.

The holding part 62 in the windshield mount 60 has the inclined shape inclined backward as proceeding outside in the vehicle width direction. Accordingly, the windshield 40 can be held on the vehicle body 14 while the deformation state where the center part of the windshield 40 protrudes to the front side in the vehicle width direction is kept.

The first windshield mount 60L is attached to the left part of the dashboard panel 3 along the vehicle width direction, and the second windshield mount 60R is attached to the right part of the dashboard panel 30 along the vehicle width direction. Accordingly, the first windshield mount 60L on the left side and the second windshield mount 60R on the right side can mount the right and left sides of the windshield 40 to the vehicle body 14.

### Modification Example

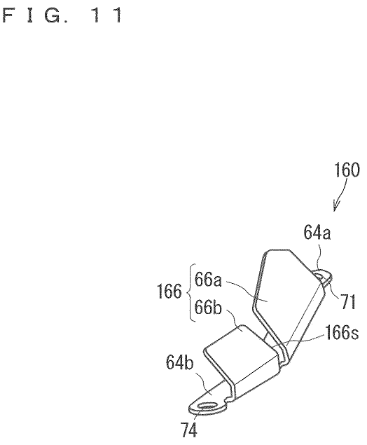

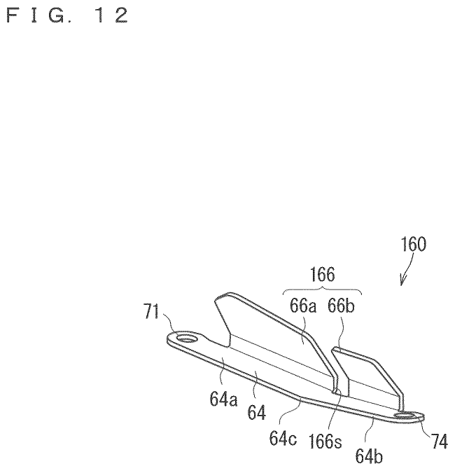

FIG. 11 and FIG. 12 are perspective views each illustrating a windshield mount 160 according to a modification example. The windshield mount 160 is a modification example of the windshield mount 60R on the right side.

In the windshield mount 160 illustrated in FIG. 11, a shape of a front retaining part 166 is different from that of the front retaining part 66 in the windshield mount 60 described above. The front retaining part 166 is divided into two parts. The front retaining part 166 includes the inner part 66a and the outer part 66b in the manner similar to the front retaining part 66. The bending part 66c is omitted in the front retaining part 166. A slit 166s is formed in the front retaining part 166 in place of the bending part 66c. The slit 166s divides the front retaining part 166 into the inner part 66a and the outer part 66b. The inner part 66a and the outer part 66b are not directly connected to each other. The inner part 66a and the outer part 66b are connected via the lower retaining part 64.

The windshield mount may not be bent. Also applicable is a configuration that a straight windshield mount is obliquely disposed. For example, the plurality of windshield mounts on one side are also applicable. For example, the windshield mount may be divided into a part including the inner parts 64a and 66a and a part including the outer parts 64b and 66b. That is to say, an inner windshield mount including the inner parts 64a and 66a and an outer windshield mount including the outer parts 64b and 66b may be provided as the windshield mount on one side. For example, one windshield mount on one side is also applicable. In this case, only one of the inner windshield mount including the inner parts 64a and 66a and the outer windshield mount including the outer parts 64b and 66b may be provided as the windshield mount on one side.

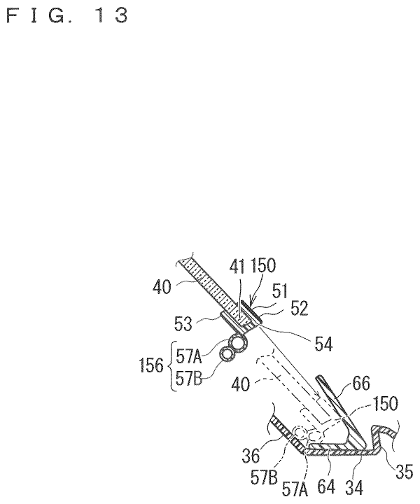

FIG. 13 is a cross-sectional view illustrating a seal lip 150 according to a modification example.

In the seal lip 150, a shape of an elastic part 156 is different from that of the elastic part 56 in the seal lip 50 described above. The elastic part 156 has a shape that the cylindrical parts 57 are continuously formed. Herein, the elastic part 156 has a shape that two cylindrical parts 57A and 57B are continuously formed. The shape is a shape such as a sign expressing infinity (∞), for example. Sizes of the cylindrical parts 57 may be the same as or different from each other. The cylindrical part 57A closer to the fitting part 51 may be larger or smaller than the cylindrical part 57B farther away from the fitting part 51. As illustrated in FIG. 13, the elastic part 156 may be deformed to be bent between the first cylindrical part 57A and the fitting part 51 or between the first cylindrical part 57A and the second cylindrical part 57B while the windshield 40 is supported on the windshield mount 60.

Configurations described in the above-mentioned embodiments and modification examples can be combined with each other as appropriate unless any contradiction occurs.

### Appendix

The present specification and the diagrams disclose each aspect described hereinafter.

A windshield mount according to a first aspect is a windshield mount mounting a windshield located in front of a seat of a vehicle to a vehicle body, including: a holding part holding a lower part of the windshield; and an attachment part detachably attached to the vehicle body, wherein the holding part has a shape bent in a front-back direction.

According to the first aspect, the holding part can hold a part of the windshield bent in the front-back direction.

A second aspect is the windshield mount according to the first aspect, wherein the holding part includes a lower retaining part located on a lower side than the windshield and a front retaining part extending upward from a front edge part of the lower retaining part to hold the lower part of the windshield from a front side.

According to the second aspect, the lower retaining part and the front retaining part can hold the windshield.

A third aspect is the windshield mount according to the second aspect, wherein each of the lower retaining part and the front retaining part is bent in a front-back direction.

According to the third aspect, the lower retaining part and the front retaining part can hold a part of the windshield bent in the front-back direction.

A fourth aspect is the windshield mount according to the second or third aspect, wherein the attachment part includes an attachment hole part in both end parts of the lower retaining part along a vehicle width direction.

According to the fourth aspect, the lower retaining part can be supported on the vehicle body.

A fifth aspect is the windshield mount according to the fourth aspect, wherein a length of the lower retaining part in the vehicle width direction is larger than a length of the front retaining part in the vehicle width direction.

According to the fifth aspect, the attachment hole can be provided to a part of the lower retaining part protruding in the vehicle width direction more than the front retaining part.

A sixth aspect is the windshield mount according to any one of the first to fifth aspects, wherein the holding part has a shape bent in an up-down direction.

According to the sixth aspect, a part of the windshield bent in the up-down direction can be held.

A seventh aspect is the windshield mount according to any one of the second to fourth aspects, wherein each of the lower retaining part and the front retaining part is bent in an up-down direction.

According to the seventh aspect, the lower retaining part and the front retaining part can hold a part of the windshield bent in the up-down direction.

An eighth aspect is the windshield mount according to any one of the first to seventh aspects, wherein the attachment part is attached to at least one of a left part and a right part of the vehicle body along a vehicle width direction, and the holding part holds the one of the left part and the right part of the lower part of the windshield along the vehicle width direction.

According to the eighth aspect, one windshield mount can mount one of the right and left sides of the windshield to the vehicle body.

A vehicle according to a ninth aspect includes: a vehicle body including a vehicle body frame having a rollover protective structure (ROPS) and a dashboard panel; a seat located more backward than the dashboard panel and supported on the vehicle body; and a windshield mount attached to the dashboard panel, wherein the windshield mount includes a holding part holding a lower part of a windshield located in front of the seat and an attachment part detachably attached to the vehicle body, and the holding part has a shape bent in a front-back direction.

According to the ninth aspect, the windshield can be attached to be bent in the front-back direction using the windshield mount in the vehicle such as a side-by-side vehicle including the ROPS.

A tenth aspect is the vehicle according to the ninth aspect, wherein the holding part includes a lower retaining part located on a lower side than the windshield and a front retaining part extending upward from a front edge part of the lower retaining part to hold the lower part of the windshield from a front side.

According to the tenth aspect, the lower retaining part and the front retaining part can hold the windshield.

An eleventh aspect is the vehicle according to the tenth aspect, wherein the attachment part includes an outer attachment part located in an outer end part of the lower retaining part along the vehicle width direction and an inner attachment part located in an inner end part of the lower retaining part along the vehicle width direction.

According to the eleventh aspect, the lower retaining part can be supported on the vehicle body.

A twelfth aspect is the vehicle according to the eleventh aspect, wherein a length of the lower retaining part in the vehicle width direction is larger than a length of the front retaining part in the vehicle width direction, the outer attachment part is located on an outer side than the front retaining part along the vehicle width direction, and the inner attachment part is located on an inner side than the front retaining part along the vehicle width direction.

According to the twelfth aspect, the front retaining part hardly becomes an obstacle when each of the outer attachment part and the inner attachment part is attached to the vehicle body.

A thirteenth aspect is the vehicle according to the eleventh or twelfth aspect, wherein a position of the outer attachment part in an up-down direction is higher than a position of the inner attachment part.

According to the thirteenth aspect, the holding part can hold the windshield to be bent upward from the inner attachment part toward the outer attachment part.

A fourteenth aspect is the vehicle according to any one of the eleventh to thirteenth aspects, wherein a position of the outer attachment part in a front-back direction is located more backward than a position of the inner attachment part.

According to the fourteenth aspect, the holding part can hold the windshield to be bent backward from the inner attachment part toward the outer attachment part.

A fifteenth aspect is the vehicle according to any one of the eleventh to fourteenth aspects, wherein a position of the outer attachment part in an up-down direction is higher than a position of the inner attachment part, and a position of the outer attachment part in a front-back direction is located more backward than a position of the inner attachment part.

According to the fifteenth aspect, the holding part can hold the windshield to be bent upward and backward from the inner attachment part toward the outer attachment part.

A sixteenth aspect is a vehicle according to any one of the ninth to fifteenth aspects, wherein the windshield mount includes a first windshield mount and a second windshield mount, the first windshield mount is attached to a left part of the dashboard panel along a vehicle width direction, and the second windshield mount is attached to a right part of the dashboard panel along the vehicle width direction.

According to the sixteenth aspect, the first windshield mount on the left side and the second windshield mount on the right side can mount the right and left sides of the windshield to the vehicle body.

A windshield mount according to a seventeenth aspect is a windshield mount mounting a windshield located in front of a seat of a vehicle to a vehicle body, including: a holding part holding a lower part of the windshield; and an attachment part detachably attached to the vehicle body, wherein the holding part has an inclined shape inclined backward as proceeding outside in a vehicle width direction.

According to the seventeenth aspect, the windshield can be held on the vehicle body while a deformation state where a center part of the windshield protrudes to a front side in the vehicle width direction is kept.

The foregoing description is in all aspects illustrative and does not restrict the present invention. Numerous modifications and variations that have not yet been exemplified are devised without departing from the scope of the present invention.

1. A windshield mount mounting a windshield located in front of a seat of a vehicle to a vehicle body, comprising:
a holding part holding a lower part of the windshield; and an attachment part detachably attached to the vehicle body, wherein
the holding part has a shape bent in a front-back direction.

2. The windshield mount according to claim 1, wherein
the holding part includes a lower retaining part located on a lower side than the windshield and a front retaining part extending upward from a front edge part of the lower retaining part to hold the lower part of the windshield from a front side.

3. The windshield mount according to claim 2, wherein
each of the lower retaining part and the front retaining part is bent in a front-back direction.

4. The windshield mount according to claim 2, wherein
the attachment part includes an attachment hole part in both end parts of the lower retaining part along a vehicle width direction.

5. The windshield mount according to claim 4, wherein
a length of the lower retaining part in the vehicle width direction is larger than a length of the front retaining part in the vehicle width direction.

6. The windshield mount according to claim 1, wherein
the holding part has a shape bent in an up-down direction.

7. The windshield mount according to claim 2, wherein
each of the lower retaining part and the front retaining part is bent in an up-down direction.

8. The windshield mount according to claim 1, wherein
the attachment part is attached to at least one of a left part and a right part of the vehicle body along a vehicle width direction, and the holding part holds the one of the left part and the right part of the lower part of the windshield along the vehicle width direction.

9. A vehicle, comprising:
a vehicle body including a vehicle body frame having a rollover protective structure (ROPS) and a dashboard panel;
a seat located more backward than the dashboard panel and supported on the vehicle body; and
a windshield mount attached to the dashboard panel,
wherein the windshield mount includes a holding part holding a lower part of a windshield located in front of the seat and an attachment part detachably attached to the vehicle body, and
the holding part has a shape bent in a front-back direction.

10. The vehicle according to claim 9, wherein
the holding part includes a lower retaining part located on a lower side than the windshield and a front retaining part extending upward from a front edge part of the lower retaining part to hold the lower part of the windshield from a front side.

11. The vehicle according to claim 10, wherein
the attachment part includes an outer attachment part located in an outer end part of the lower retaining part along the vehicle width direction and an inner attachment part located in an inner end part of the lower retaining part along the vehicle width direction.

12. The vehicle according to claim 11, wherein
a length of the lower retaining part in the vehicle width direction is larger than a length of the front retaining part in the vehicle width direction,
the outer attachment part is located on an outer side than the front retaining part along the vehicle width direction, and
the inner attachment part is located on an inner side than the front retaining part along the vehicle width direction.

13. The vehicle according to claim 11, wherein
a position of the outer attachment part in an up-down direction is higher than a position of the inner attachment part.

14. The vehicle according to claim 11, wherein
a position of the outer attachment part in a front-back direction is located more backward than a position of the inner attachment part.

15. The vehicle according to claim 11, wherein
a position of the outer attachment part in an up-down direction is higher than a position of the inner attachment part, and
a position of the outer attachment part in a front-back direction is located more backward than a position of the inner attachment part.

16. The vehicle according to claim 9, wherein
the windshield mount includes a first windshield mount and a second windshield mount,
the first windshield mount is attached to a left part of the dashboard panel along a vehicle width direction, and
the second windshield mount is attached to a right part of the dashboard panel along the vehicle width direction.

17. A windshield mount mounting a windshield located in front of a seat of a vehicle to a vehicle body, comprising:
a holding part holding a lower part of the windshield; and an attachment part detachably attached to the vehicle body, wherein
the holding part has an inclined shape inclined backward as proceeding outside in vehicle width direction.
